(19) United States
(12) Patent Application Publication
(10) Pub. No.: US 2021/0292079 A1
(43) Pub. Date: Sep. 23, 2021

(54) DISPOSABLE INSULATED DRINKING VESSEL AND METHOD OF MAKING THE SAME

(71) Applicant: Ecopax, LLC, Easton, PA (US)

(72) Inventor: Chihming Wong, Easton, PA (US)

(21) Appl. No.: 17/194,652

(22) Filed: Mar. 8, 2021

Related U.S. Application Data
(60) Provisional application No. 62/990,567, filed on Mar. 17, 2020.

(51) Int. Cl. B65D 81/38; B65D 1/26; B32B 7/12; B32B 29/00; B32B 3/26

(52) U.S. Cl. CPC B65D 81/3886; B65D 1/265; B32B 7/12; B32B 2307/718; B32B 3/263; B32B 2307/304; B32B 2439/70; B32B 29/005

(57) ABSTRACT

An insulating disposable vessel for holding a liquid and method of making it. The vessel is made up of a paper cup and a laminated wrap. The cup has a sidewall and a bottom wall. The laminated wrap has opposed marginal side edges and is wrapped about the sidewall with the marginal edges overlapping each other in an overlapped joint. The laminated wrap is formed from a strip having an outer layer formed of paper, and an inner layer formed of embossed paper towel material. The strip is wrapped around the sidewall with the inner layer interposed between the sidewall and the outer layer resulting in a plurality of thermally insulating air pockets providing thermal insulation for the cup.

### CROSS-REFERENCE TO RELATED APPLICATIONS

This utility application claims the benefit under 35 U.S.C. § 119(e) of Provisional Application Ser. No. 62/990,567 filed on Mar. 17, 2020 entitled Disposable Insulated Drinking Vessel and Method of Making the Same. The entire disclosure of the provisional application is incorporated by reference herein.

### FIELD OF THE INVENTION

This invention relates generally to disposable vessels for holding beverages and more specifically to disposable beverage cups formed of paper whose sidewalls include a thermally insulating paper-based wrap and methods of making the same.

### SPECIFICATION

### BACKGROUND OF THE INVENTION

Disposable cups for hot beverages, such as coffee, tea, soup, etc., are available in various configurations. Some such cups are formed entirely of a foamed plastic, e.g., polystyrene, so that the cup is heat insulating and can be readily held in a user's hand when filled with a hot beverage. Other commercially available cups are composed of paper with at least one layer of a plastic foam thermally insulating material at the sidewall of the cup so that the heat from the liquid in the cup can't readily penetrate through the sidewall to the hand of a person holding the cup. While such disposable cups may provide good heat-insulating properties, their plastic content renders them non-biodegradable. A variety of all-paper cups have been proposed and many are available commercially as environmentally acceptable alternatives to cups including plastic material insulation. However, such all-paper cups leave something to be desired from one or more standpoints of: complexity, cost, ease of manufacture, insulating ability. Thus, a need exists for a cup that is essentially all paper and which overcomes the disadvantages of the prior art. The subject invention addresses that need.

### BRIEF SUMMARY OF THE INVENTION

One aspect of this invention is a disposable insulating vessel, e.g., beverage cup, for holding a liquid therein. The insulating vessel comprises a cup-shaped body and a laminated wrap. The cup-shaped body has a circumferential sidewall and a bottom wall. The circumferential sidewall is formed of paper, and has an outer surface, a top end and a bottom end. The laminated wrap extends about the circumferential sidewall of the cup-shaped body between the top end and the bottom end. The laminated wrap has a top edge, a bottom edge, and opposed marginal side edges. The opposed marginal edges overlap and are secured to each other by an overlapped joint. The laminated wrap comprises an outer layer and an inner layer. The outer layer is formed of paper and has an inner surface. The inner layer is formed of an embossed paper towel material. The inner layer has an inner surface and an outer surface. The inner surface of the outer layer is secured to the outer surface of the inner layer. The inner surface of the inner layer is secured to the outer surface of the circumferential sidewall, whereupon a plurality of thermally insulating air pockets are located between the outer surface of the circumferential sidewall and the outer layer of the laminated wrap.

In accordance with one preferred aspect of the disposable insulating vessel of this invention, the inner layer has a basis weight within the range of range of approximately 12 pounds to approximately 50 pounds per 3000 square feet.

In accordance with another preferred aspect of the disposable insulating vessel of this invention, the inner layer has a caliper within the range of approximately 0.005 inch to approximately 0.02 inch.

In accordance with another preferred aspect of the disposable insulating vessel of this invention, the outer layer has a basis weight of approximately 90 pounds to approximately 215 pounds per 3000 square feet.

In accordance with another preferred aspect of the disposable insulating vessel of this invention, the outer layer has a caliper within the range of approximately 0.015 inch to approximately 0.035 inch.

In accordance with another preferred aspect of the disposable insulating vessel of this invention, the inner surface of the outer layer and the outer surface of the inner layer are secured together by an adhesive.

In accordance with another preferred aspect of the disposable insulating vessel of this invention, the inner surface of the inner layer is secured to the outer surface of the circumferential sidewall by frictional engagement.

In accordance with another preferred aspect of the disposable insulating vessel of this invention, the circumferential sidewall tapers downward in diameter from the top edge to the bottom edge.

In accordance with another preferred aspect of the disposable insulating vessel of this invention, the top edge of the laminated wrap is disposed immediately adjacent to the top edge of the circumferential sidewall.

In accordance with another preferred aspect of the disposable insulating vessel of this invention, the bottom edge of the laminated wrap is disposed immediately adjacent to the bottom edge of the circumferential sidewall.

In accordance with another preferred aspect of the disposable insulating vessel of this invention, the bottom edge of the laminated wrap is disposed spaced from the bottom edge of the circumferential sidewall.

Another aspect of this invention is a method of making a disposable insulated vessel for holding a liquid. The method comprises providing a cup-shaped body having a circumferential sidewall and a bottom wall. The circumferential sidewall is formed of paper, having an outer surface, a top end and a bottom end. A laminated strip is provided. The laminated strip has a top edge, a bottom edge, and opposed marginal side edges. The laminated strip comprises an outer layer and an inner layer. The outer layer is formed of a paper and has an inner surface. The inner layer is formed of an embossed paper towel material. The inner layer has an inner surface and an outer surface. The inner surface of the outer layer is secured to the outer surface of the inner layer. The laminated strip is wrapped around the circumferential sidewall to form a laminated wrap. The marginal edges of the laminated wrap are caused to overlap each other, with the inner surface of the inner layer engaging the outer surface of the circumferential sidewall, whereupon a plurality of insulating air pockets are located between the outer layer of the laminated wrap and the outer surface of the circumferential sidewall. Those overlapping marginal edges are secured together, whereupon said the surface of the inner layer of the laminated wrap is secured to the outer surface of the circumferential sidewall.

In accordance with one preferred aspect of the method of this invention, the inner surface of the inner layer is secured to the outer surface of said circumferential sidewall by frictional engagement.

In accordance with another preferred aspect of the method of this invention, the inner surface of said outer layer and the outer surface of said inner layer are secured together by an adhesive.

In accordance with another preferred aspect of the method of this invention, the inner layer has a basis weight within the range of range of approximately 12 pounds to approximately 50 pounds per 3000 square feet.

In accordance with another preferred aspect of the method of this invention, the outer layer has a basis weight in the range of approximately 90 pounds to approximately 215 pounds per 3000 square feet.

In accordance with another preferred aspect of the method of this invention, the inner layer has a caliper within the range of approximately 0.005 inch to approximately 0.02 inch.

In accordance with another preferred aspect of the method of this invention, the outer layer has a caliper within the range of approximately 0.015 inch to approximately 0.035 inch.

In accordance with another preferred aspect of the method of this invention, the circumferential sidewall tapers downward in diameter from said top edge to said bottom edge.

In accordance with another preferred aspect of the method of this invention, the top edge of the laminated wrap is disposed immediately adjacent to the top edge of the circumferential sidewall.

In accordance with another preferred aspect of the method of this invention, the bottom edge of the laminated wrap is disposed immediately adjacent to the bottom edge of the circumferential sidewall.

In accordance with another preferred aspect of the method of this invention, the bottom edge of said laminated wrap is disposed spaced from said bottom edge of said circumferential sidewall.

### BRIEF DESCRIPTION OF SEVERAL VIEWS OF THE DRAWINGS

FIG. 1 is a side elevation view of one exemplary embodiment of a disposable insulated vessel constructed in accordance with this invention;

FIG. 2 is an isometric exploded view of the two components making up the disposable insulated vessel shown in FIG. 1, those components being a core in the form of a paper cup having a sidewall and a laminated insulated wrap secured about the sidewall of the paper cup;

FIG. 3 is a greatly enlarged sectional view, not to scale, taken along line 3-3 of FIG. 1;

FIG. 4 is a greatly enlarged sectional view, not to scale, taken along line 4-4 of FIG. 1;

FIG. 5 is a top plan view, not to scale, of a strip of a laminated insulated web that is wrapped about the paper cup to complete the vessel shown in FIG. 1;

FIG. 6 is an enlarged sectional view, not to scale, taken along line 6-6 of FIG. 5; and

FIG. 7 is a sectional view, like that of FIG. 4, but showing an alternative embodiment of a disposable insulated vessel constructed in accordance with this invention.

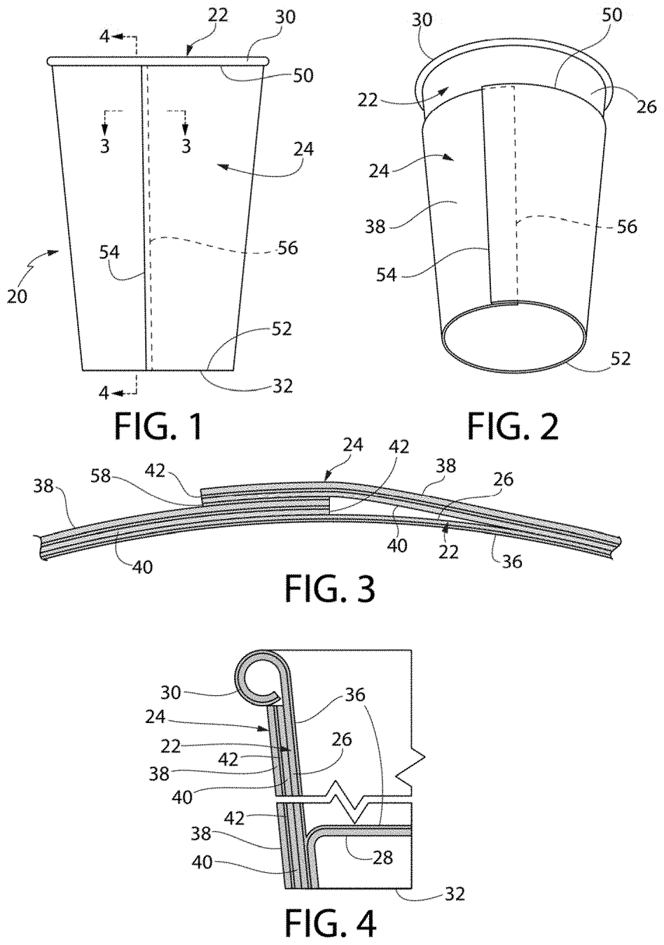

### DETAILED DESCRIPTION OF THE PREFERRED EMBODIMENTS OF THE INVENTION

Referring now to the various figures of the drawing wherein like reference characters refer to like parts, there is shown at 20 in FIG. 1 one exemplary embodiment of a disposable insulated vessel constructed in accordance with this invention. The vessel 20 basically comprises a cup 22 and a thermally insulating wrap 24. The cup and the wrap are formed essentially of paper. The cup is of conventional construction and includes a peripheral sidewall 26 and a bottom wall 28. The sidewall 26 has a top edge 30 and a bottom edge 32 and tapers down in diameter from the top edge to the bottom edge at a slight acute angle, e.g., approximately 5.6 degrees. The top edge 30 is rolled to form the drinking lip of the cup as is conventional.

The bottom wall 28 of the cup is planar and circular in profile. The outer periphery of the bottom wall is in the form of a downwardly directed peripheral flange 34, which is fixedly secured to the inner surface of the cup's sidewall just above the cup's bottom edge 32, as best seen in FIG. 4. As is conventional the inner surface of the sidewall of the cup and the inner surface of the bottom wall of the cup include a thermoplastic, e.g., polyethylene, coating 36. The coating 36 renders the sidewall and bottom of the cup resistant to liquid absorption and also serves as the means for securing the flange 34 of bottom wall to the sidewall 26 of the cup.

The thermally insulating wrap 24 is in the form of a lamination that is cut into a strip and tightly wrapped about the cup's sidewall 26 to secure it to the sidewall by friction, as will be described later. The lamination making up the wrap basically comprises an outer layer 38 and an inner layer 40 which are coextensive is size and secured together by an interposed adhesive 42, e.g., a water based adhesive. The outer layer 38 is formed of paper which has a basis weight in the range of approximately 90 pounds to approximately 215 pounds per 3000 square feet, with the most preferred basis weight of approximately 90 pounds per 3000 square feet. The caliper of the outer layer 36 is in the range of approximately 0.015 inch to approximately 0.035 inch, with the most preferred caliper being 0.015 inch. The inner layer 40 is formed of an embossed low density paper, such as used for conventional paper hand towels. In accordance with one preferred aspect of this invention the paper towel material inner layer has a basis weight within the range of approximately 12 pounds to approximately 50 pounds per 3000 square feet, with the most preferred basis weight being approximately 12 pounds per 3000 square feet. The caliper of the paper towel material inner layer is in the range of approximately 0.005 inch to approximately 0.02 inch, with the most preferred caliper being 0.005 inch.

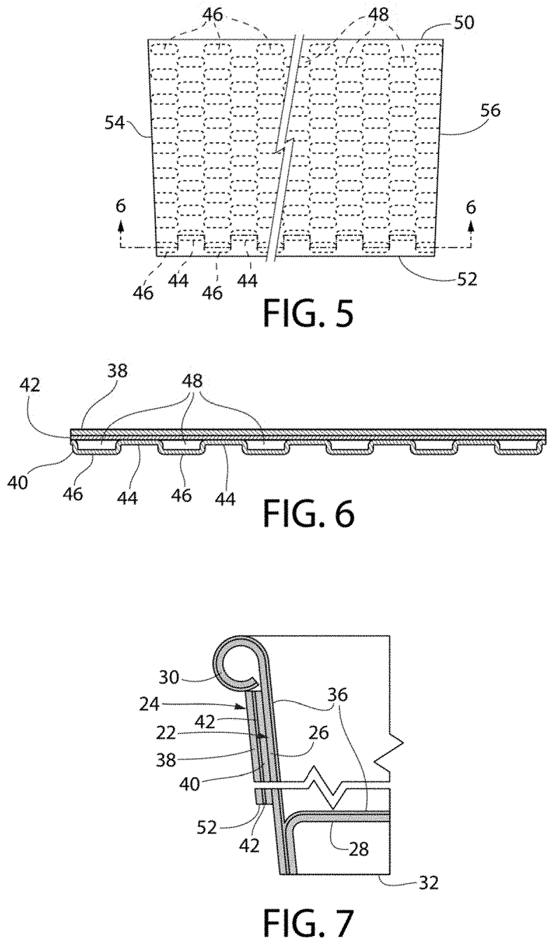

In accordance with one preferred aspect of this invention the material making up the paper towel layer 28 of the laminated wrap 24 is preferably embossed, as is commonly found in conventional paper hand towels. The embossing of the paper towel layer 28 enhances its thermal insulating properties when it is combined with the outer paper layer to form the lamination. In particular the securement of the inner and outer layers together forms a plurality of thermally insulating air pockets therebetween, as will be described shortly. The particular shape and configuration of the embossments can take numerous forms so that the embossed paper towel layer has a multitude of peaks and/or valleys. In the exemplary embodiment shown in FIGS. 5 and 6 the paper towel layer 28 has a multitude of embossments in the form of elongated rounded end peaks 44 and a multitude of correspondingly shaped and sized elongated rounded end valleys 46 interposed between adjacent peaks. The embossments shown in FIGS. 5 and 6 are merely exemplary, and thus can take other various shapes and be of other sizes and layouts than shown in FIGS. 5 and 6. In fact, it is contemplated that the embossed paper towel layer 28 can be made so that it only includes either plural peak embossments 44 or plural valley embossments 46, and not plural peak and valley embossments.

The making of the laminated wrap is accomplished as follows. A web of un-embossed paper (which will be used to form the outer layer 38 of the laminated wrap) is superimposed over a web of embossed paper towel material (which will be used to form the inner layer 40 of the laminated wrap), with the adhesive 42 applied at their interface. The two webs are then brought into engagement so that the interposed adhesive 42 fixedly secures the top surface of the peaks 44 of the embossed towel material web to the undersurface of the paper web thereby laminating the two webs together and forming the plurality of insulating air pockets 48 therebetween like shown in FIG. 6 (the interposed adhesive 42 not being shown in this figure). The resulting laminated web is then cut into a laminated strip, like shown in FIG. 5, having a desired shape, e.g., a trapezoid, which is sized and shaped to enable it to be wrapped about and secured the outer surface of the sidewall of the cup. In particular, the strip to which the laminated web is cut has a top edge 50, a bottom edge 50, a first slightly angled side edge 52 and a second and opposite slightly angled side edge 54. The laminated strip is then tightly wrapped around the outer surface of the sidewall 26 of the cup 22 so that the undersurface of the inner layer (the paper towel layer 40) is in engagement with the outer surface of the sidewall 26 of the cup, with the portions of the laminated strip contiguous with the marginal angled edges side edges 52 and 54 overlapping each other as best seen in FIG. 3. The overlapping edges are fixedly secured together by an interposed layer of adhesive58 to form an overlapped joint thereat. Any suitable adhesive, e.g., a water based adhesive, may be used to secure the overlapped edge portions together to form the joint.

In any case the tight wrapping of the laminated strip about the sidewall of the cup secures the wrap to the cup by frictional engagement sufficient to prevent the wrap from sliding off of the cup. Moreover, the frictional engagement of the undersurface of the wrap with the outer surface of the sidewall of the cup also results in the formation of other insulating air pockets between the embossed towel layer and the outer surface of the sidewall of the cup. Those other air pockets, along with the air pockets 48 located between the lower layer 40 and the upper layer 38 provide additional thermally insulating properties to the vessel 20.

As best seen in FIGS. 1 and 6 the thermally insulating wrap of the embodiment 20 extends virtually the entire height of the sidewall of the cup, i.e., from immediately below the rolled top edge 30 to the bottom edge 32. In another exemplary embodiment of a disposable beverage vessel constructed in accordance with this invention, which is shown in FIG. 7, the bottom edge of the thermally insulating wrap is located above the bottom edge of the cup.

It must be pointed out at this juncture that various changes can be made to disposable thermally insulating vessels from the exemplary embodiments shown and described above. For example, other paper-based low density materials can be used in lieu of the embossed paper towel material so long as such materials provide sufficient thermal insulation and a low cost in view of the fact that the vessels of the subject invention are disposable and normally for one-time use. Moreover, the embossed paper towel layer need not have embossments that are in the form of peaks and valleys like discussed above, so long as the embossment results in the formation of insulating air pockets when the laminated strip making up the wrap 25 is wrapped about the cup 22. Furthermore, the strip that is cut to form the wrap need not be a trapezoid, so long as the marginal side edges can be overlapped and secured to each other to frictionally hold the wrap in place on the cup. In fact, while it is preferred that the insulating wrap be secured to the outer surface of the sidewall of the cup by frictional engagement, other means for securing the wrap can be used, if desired. Such other means can be in the form of an adhesive or can be in the form of an interposed thermoplastic coating which is melted to secure the insulating wrap to the outer surface of the sidewall of the cup. Further still, the dimension and proportions of the vessel can be changed from that shown and described above.

Without further elaboration the foregoing will so fully illustrate my invention that others may, by applying current or future knowledge, adopt the same for use under various conditions of service.

I claim:

1. A disposable insulating vessel for holding a liquid therein comprising:
a cup-shaped body having a circumferential sidewall and a bottom wall, said circumferential sidewall being formed of paper, having an outer surface, a top end and a bottom end; and
a laminated wrap extending about said circumferential sidewall of said cup-shaped body between said top end and said bottom end, said laminated strip having a top edge, a bottom edge, and opposed marginal side edges, said opposed marginal edges overlapping and secured to each other by an overlapped joint, said laminated wrap comprising an outer layer and an inner layer, said outer layer being formed of paper and having an inner surface, said inner layer being formed of an embossed paper towel material, said inner layer having an inner surface and an outer surface, said inner surface of said outer layer being secured to said outer surface of said inner layer, said inner surface of said inner layer being secured to said outer surface of said circumferential sidewall, whereupon a plurality of thermally insulating air pockets are located between said outer surface of said circumferential sidewall and said outer layer of said laminated wrap.

2. The disposable insulating vessel of claim 1, wherein said inner layer has a basis weight within the range of range of approximately 12 pounds to approximately 50 pounds per 3000 square feet.

3. The disposable insulating vessel of claim 1, wherein said inner layer has a caliper within the range of approximately 0.005 inch to approximately 0.02 inch.

4. The disposable insulating vessel of claim 1, wherein said outer layer has a basis weight of approximately 90 pounds to approximately 215 pounds per 3000 square feet.

5. The disposable insulating vessel of claim 2, outer layer has a basis weight of approximately 90 pounds to approximately 215 pounds per 3000 square feet.

6. The disposable insulating vessel of claim 1, wherein said outer layer has a caliper within the range of approximately 0.015 inch to approximately 0.035 inch.

7. The disposable insulating vessel of claim 3, wherein said outer layer has a caliper within the range of approximately 0.015 inch to approximately 0.035 inch.

8. The disposable insulating vessel of claim 1, wherein said inner surface of said outer layer and said outer surface of said inner layer are secured together by an adhesive.

9. The disposable insulating vessel of claim 1, wherein said inner surface of said inner layer is secured to said outer surface of said circumferential sidewall by frictional engagement.

10. The disposable insulating vessel of claim 1, wherein said circumferential sidewall tapers downward in diameter from said top edge to said bottom edge.

11. The disposable insulating vessel of claim 1, wherein said top edge of said laminated to wrap is disposed immediately adjacent to said top edge of said circumferential sidewall.

12. The disposable insulating vessel of claim 1, wherein said bottom edge of said laminated wrap is disposed immediately adjacent to said bottom edge of said circumferential sidewall.

13. The disposable insulating vessel of claim 12, wherein said bottom edge of said laminated wrap is disposed immediately adjacent to said bottom edge of said circumferential sidewall.

14. The disposable insulating vessel of claim 1, wherein said bottom edge of said laminated wrap is disposed spaced from said bottom edge of said circumferential sidewall.

15. The insulating vessel of claim 12, wherein said bottom edge of said laminated wrap is disposed spaced from said bottom edge of said circumferential sidewall.

16. A method of making an insulated vessel for holding a liquid, said method comprising:
providing a cup-shaped body having a circumferential sidewall and a bottom wall, said circumferential sidewall being formed of paper, having an outer surface, a top end and a bottom end;
providing a laminated strip having a top edge, a bottom edge, and opposed marginal side edges, said laminated strip comprising an outer layer and an inner layer, said outer layer being formed of a paper and having an inner surface, said inner layer being formed of an embossed paper towel material, said inner layer having an inner surface and an outer surface, said inner surface of said outer layer being secured to said outer surface of said inner layer; and
wrapping said laminated strip around said circumferential sidewall to form a laminated wrap;
causing said marginal edges of said laminated wrap to overlap each other, with said inner surface of said inner layer engaging said outer surface of said circumferential sidewall, whereupon a plurality of thermally insulating air pockets is located between said outer layer of said laminated wrap and said outer surface of said circumferential sidewall; and
securing said overlapping marginal edges together, whereupon said inner surface of said inner layer is secured to said outer surface of said circumferential sidewall.

17. The method of claim 16, wherein said inner surface of said inner layer is secured to said outer surface of said circumferential sidewall by frictional engagement.

18. The method of claim 16, wherein said inner surface of said outer layer and said outer surface of said inner layer are secured together by an adhesive.

19. The method of claim 17, wherein said inner surface of said outer layer and said outer surface of said inner layer are secured together by an adhesive.

20. The method of claim 16, wherein said inner layer has a basis weight within the range of range of approximately 12 pounds to approximately 50 pounds per 3000 square feet.

21. The method of claim 16, wherein said outer layer has a basis weight in the range of approximately 90 pounds to approximately 215 pounds per 3000 square feet.

22. The method of claim 20, wherein said outer layer has a basis weight in the range of approximately 90 pounds to approximately 215 pounds per 3000 square feet.

23. The method of claim 16, wherein said inner layer has a caliper within the range of approximately 0.005 inch to approximately 0.02 inch.

24. The method of claim 16, wherein said outer layer has a caliper within the range of approximately 0.015 inch to approximately 0.035 inch.

25. The method of claim 23, wherein said outer layer has a caliper within the range of approximately 0.015 inch to approximately 0.035 inch.

26. The method of claim 16, wherein said circumferential sidewall tapers downward in diameter from said top edge to said bottom edge.

27. The method of claim 16, wherein said top edge of said laminated wrap is disposed immediately adjacent to said top edge of said circumferential sidewall.

28. The method of claim 16, wherein said bottom edge of said laminated wrap is disposed immediately adjacent to said bottom edge of said circumferential sidewall.

29. The method of claim 16, wherein said bottom edge of said laminated wrap is disposed immediately adjacent to said bottom edge of said circumferential sidewall.

30. The method of claim 16, wherein said bottom edge of said laminated wrap is disposed spaced from said bottom edge of said circumferential sidewall.
